(19) United States
(12) Patent Application Publication
(10) Pub. No.: US 2026/0336338 A1
(43) Pub. Date: Oct. 29, 2026

(54) HYBRID OFF-ROAD VEHICLE DRAG LINE

(71) Applicant: MercuryPM Pty Ltd, Kilsyth (AU)

(72) Inventor: Stephen Handbury, Kilsyth (AU)

(21) Appl. No.: 19/111,742

(22) PCT Filed: Sep. 15, 2023
(86) PCT No.: PCT/AU2023/050893

§ 371 Date: Mar. 13, 2025

(30) Foreign Application Priority Data
Sep. 19, 2022 (AU) 2022902705

(51) Int. Cl. B60D 1/18

(52) U.S. Cl. CPC B60D 1/18

(57) ABSTRACT

A hybrid off-road vehicle drag line used for recovery purposes consists of three main components: a distal chain section, a rope midsection, and a proximal shackle. The shackle is attached to the vehicle's recovery point, while the distal chain section is wrapped around an obstacle like a log. The shackle is intentionally designed to have a lower breaking strain rating than the distal chain section and rope midsection. This intentional weakness in the shackle acts as a safety feature. If the line's breaking strain is exceeded, the shackle will fail, and the distal chain section and rope midsection will move away from the vehicle, reducing the risk of vehicle damage or harm to the occupants due to backlash.

### FIELD OF THE INVENTION

This invention relates generally to off-road vehicle recovery accessories. More particularly, this invention relates to a hybrid off-road vehicle drag line recovery system consisting of a distal chain section, rope midsection, and a proximal shackle intentionally designed with a lower breaking strain rating to enhance safety during recovery operations, preventing potential vehicle damage and occupant harm.

### BACKGROUND OF THE INVENTION

In the off-road vehicle industry, drag chains are employed to clear obstacles from the path. These chains typically consist of a full 5-meter length of chain, connected to a vehicle's recovery point at one end using a steel bow shackle, and wrapped around an obstacle at the other end.

To save on weight, chains with lower breaking strain ratings are often used. For instance, many standard kits use chains with a breaking strain rating of 5800 kg. However, during recovery operations, the obstacle can become entangled, potentially exceeding the chain's breaking strain. This can lead to chain breakage at any point along its length, causing a section near the vehicle to fly back, posing a risk of vehicle damage or harm to its occupants.

Using rope is avoided because its elasticity, when compared to chain, would only increase the potential energy of any backlash, making it less safe for recovery purposes.

The present invention seeks to provide a way which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

There is provided herein a hybrid off-road vehicle towing system consisting of a distant chain section, a midsection made of rope, and a proximal shackle.

The proximal shackle is affixed to a recovery point on a vehicle, while the distant chain section is wound around an obstacle, such as a log.

The proximal shackle serves as a safety feature deliberately designed to have a lower breaking strain rating than that of the distant chain section and the rope midsection. In a preferred design, the shackle takes the form of a soft shackle.

For instance, the distant chain section and the rope midsection may possess a breaking strain rating exceeding 6000 kg, whereas the shackle may have a breaking strain rating of less than 6000 kg. Consequently, the shackle represents the weakest point in the system and would fail if the line's breaking strain is exceeded. Given that the soft shackle is connected to the vehicle, the distant chain section and the rope midsection would move away from the vehicle, eliminating the risk of vehicle damage or harm to occupants due to any sudden backlash.

The shorter distant chain section also allows for the use of a heavier gauge chain while staying within weight limitations.

This rope midsection is preferably constructed using non-thermoplastic rope fibre with a melting point exceeding 300°, ensuring its suitability for use in bushfire situations.

The drag line encompasses various components, including sleeves, hooks, disconnection shackles, and similar elements, enhancing its durability and facilitating ease of use and customization.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 illustrates dragging an obstacle with an off-road vehicle using an off-road vehicle drag line; and

FIG. 2 shows a perspective view of the off-road vehicle drag line.

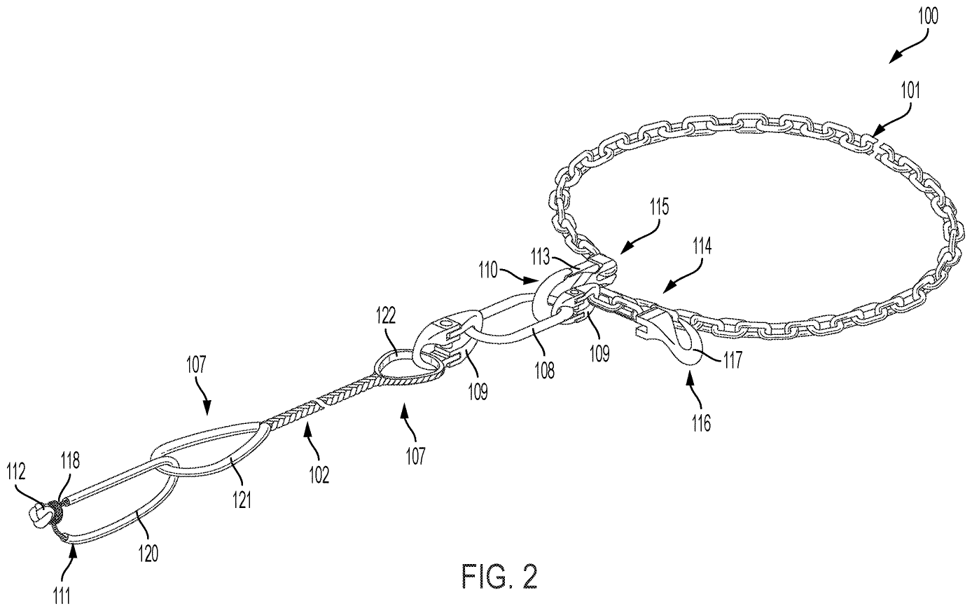

### DESCRIPTION OF EMBODIMENTS

An off-road vehicle drag line 100 comprises a distal chain section 101, rope midsection 102 and a proximal shackle 103.

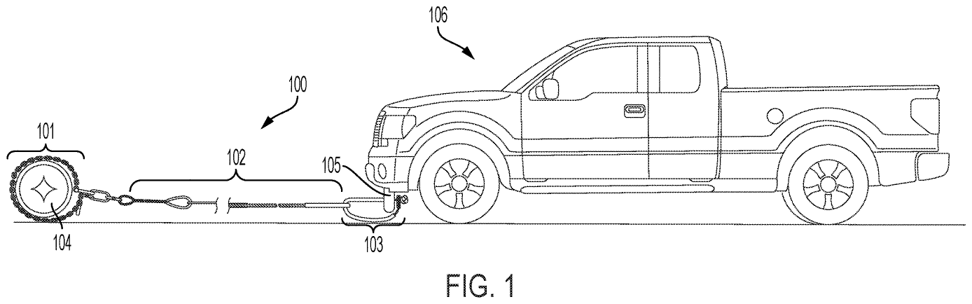

As is shown in FIG. 1, the proximal shackle 103 is attached to a recovery point 105 of an off-road vehicle 106 and the distal chain section 101 is wrapped around an obstacle 104, shown as a log. The configuration shown, the vehicle 106 is reversed to drag the obstacle 104.

The proximal shackle 103 acts as a safety feature because it has a lower breaking strain rating than that of the distal chain section 101 and the rope midsection 102.

As such, if the breaking strain of the shackle 103 is exceeded (such as if the obstacle 104 becomes snagged), the proximal shackle 103 breaks whereas the distal chain section 101 and the rope midsection 102 does not. As such, the distal chain section 101 and the rope midsection 103 safely catapults away from the vehicle 106.

The broken shackle 103 can then be replaced with a replacement shackle 103.

In embodiments, the distal chain section 101 comprises chain having a breaking strain in excess of approximately 6000 kg. Furthermore, the rope midsection 102 may similarly have a breaking strain in excess of 6000 kg. However, the shackle 103 may be configured to have a breaking strain rating of less than 6000 kg. As such, the shackle 103 represents the weakest point of the drag chain line 100 thereby safely preventing rope or chain backlash towards the vehicle 106 in the event of failure.

According to the preferred embodiment shown, the shackle 103 is a soft shackle 111. The soft shackle 111 comprises rope that forms a closed-loop, the rope having a noose 118 at one end and a stopper knot 112 at an opposite end thereof. Where the soft shackle 111 comprises the same material as that of the rope midsection 102, the soft shackle 111 may be designed to have a lower breaking strain by having rope less than half the diameter of that of the rope midsection 102.

The soft shackle 111 may comprise an abrasion resistance sleeve 120 to reduce fibre abrasion against the recovery point 105 or the rope midsection 102.

The rope midsection 102 may have permanently formed eye splices 107 interfacing the shackle 103 and the distal chain section 101 respectively.

The rope midsection 102 may have a metallic rope thimble 122 interfacing the distal chain section 101. Furthermore, the rope midsection 102 may have an abrasion resisting sleeve 121 interfacing the proximal shackle 103.

Preferably, the rope midsection 102 and/or the soft shackle 103 comprises synthetic rope material. Preferably, the synthetic rope material has a high melting point so that the drag chain line 100 can be used in bushfire situations. Preferably, the synthetic rope material has a melting point in excess of 300 °C. Preferably, the synthetic rope material does not comprise thermoplastic which may have a melting point at between 135 to 150 °C.

In one embodiment, the synthetic rope material comprises aromatic copolyamide fibre, such as Technora™ which has significant heat advantages over traditional thermoplastic UHMWPE fiber. Specifically, Technora™ fiber decomposes at 500 °C compared to 550 °C for PPD-T fiber. Furthermore, Technora™ has an ignition point of about 650 °C and a heat of combustion of about 6800 cal g-1.

Furthermore, the specific heat of Technora™ fiber is about 0.26 cal g-1 °C-1 as compared with 0.4 cal g-1 °C-1 for PPD-T fiber.

In comparison, thermoplastic UHMWPE fibers have a low melting point at approximately 135 to 150 °C. Thermoplastic polymer can potentially melt into a liquid when exposed to high heat which could spread fire.

The distal chain section 101 may define a fixed end 114 and a free end 115. The free end 115 may terminate in a hook 110 used to form a loop. The hook 110 may comprise a gate 113.

An oval ring 108 may interface the distal chain section 101 and the rope midsection 102. The hook 110 may attach directly to the oval ring 118.

The line 100 may comprise disconnection shackles 109 either side of the oval ring 108. The disconnection shackles 109 may be used to replaceably attach the rope midsection 102 and the distal chain section 101 to the oval ring 108. Each disconnection shackle 109 may comprise two halves which may be separated with the removal of a pin.

The line 100 may further comprise a chain hook 116 at the fixed end 114. The chain hook 116 may be configured to attach at any point along the distal chain section 101 to form a smaller loop of chain if required. The hook 116 may comprise chain-link accommodating channels 117 either side thereof.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. An off-road vehicle drag line comprising a distal chain section, rope midsection and proximal shackle, wherein the shackle has a lower breaking strain rating than that of the distal chain section and rope midsection.

2. The drag line as claimed in claim 1, wherein the distal chain section and the rope midsection having a breaking strain rating greater than 6000 kg and the shackle has a breaking strain rating less than 6000 kg.

3. The drag line as claimed in claim 1, wherein the shackle is a soft shackle.

4. The drag line as claimed in claim 3, wherein the soft shackle comprises rope that forms a closed loop, the rope having a noose and a stopper knot at either end thereof.

5. The drag line as claimed in claim 3, wherein the shackle has a sleeve interfacing the rope midsection.

6. The drag line as claimed in claim 3, wherein the soft shackle has rope less than half the diameter of that of the rope midsection.

7. The drag line as claimed in claim 1, wherein the rope midsection has an eye splice interfacing the shackle.

8. The drag line as claimed in claim 1, wherein the rope midsection has an eye splice interfacing the distal chain section.

9. The drag line as claimed in claim 8, wherein the rope midsection has a rope thimble interfacing the eye splice.

10. The drag line as claimed in claim 7, wherein the rope midsection has a sleeve interfacing the shackle.

11. The drag line as claimed in claim 1, wherein the rope midsection comprises synthetic rope material which does not comprise thermoplastic.

12. The drag line as claimed in claim 1, wherein the rope midsection comprises synthetic rope material having a melting point in excess of 300 °C.

13. The drag line as claimed in claim 1, wherein the rope midsection comprises synthetic rope material comprising aromatic copolyamides.

14. The drag line as claimed in claim 1, wherein the distal chain section has a fixed end and a free end, the free end terminating in a hook.

15. The drag line as claimed in claim 14, wherein the hook has a gate.

16. The drag line as claimed in claim 14, wherein a ring interfaces the distal chain section and the rope midsection and wherein the hook attaches to the ring.

17. The drag line as claimed in claim 1, further comprising a disconnection shackle interfacing the distal chain section and the rope midsection.

18. The drag line as claimed in claim 14, further comprising a chain hook at the fixed end, the chain hook configured to attach at any point along the distal chain section.

19. A method of dragging an obstacle using the off-road vehicle drag line as claimed in claim 1, the method comprising attaching the shackle to an attachment point of an off-road vehicle, wrapping the distal chain section around the obstacle in reversing the vehicle to drag the obstacle.

20. The method as claimed in claim 19, wherein the method further comprises exceeding the breaking strain of the shackle so that the shackle breaks and replacing the shackle with another shackle.
